(19) United States
(12) Patent Application Publication
(10) Pub. No.: US 2010/0311860 A1
(43) Pub. Date: Dec. 9, 2010

(54) METHOD FOR MAKING PROTON CONDUCTING MEMBRANES FOR FUEL CELLS BY RADIOGRAFTING

(75) Inventors: Thomas Berthelot, Villebon Sur Yvette (FR); Marie-Claude Clochard, Sartrouville (FR)

Correspondence Address: Nixon Peabody LLP, P.O. Box 60610, Palo Alto, CA, 94306, US

(73) Assignee: COMMISSARIAT A L'ENERGIE ATOMIQUE, Paris (FR)

(21) Appl. No.: 12/679,300

(22) PCT Filed: Sep. 24, 2008
(86) PCT No.: PCT/EP2008/062732

§ 371 Date: Mar. 19, 2010

(30) Foreign Application Priority Data
Sep. 26, 2007 (FR) 07 57875

(51) Int. Cl. C08J 3/28

(52) U.S. Cl. 522/136; 522/144

(57) ABSTRACT

A method for producing a proton-conducting membrane for a fuel cell, comprising successively: irradiating a polymeric matrix; grafting said polymeric matrix thus irradiated, by free-radical reaction with a first compound, comprising contacting said irradiated polymeric matrix with said first compound, which comprises at least one group capable of forming a covalent bond by free-radical reaction with said matrix, and comprises at least one reactive group capable of reacting with a group of a second compound, comprising at least one proton-conducting acid group, to form a covalent bond; and contacting with the second compound the matrix thus grafted, whereby there is reaction between the reactive groups from the first compound and the appropriate groups of the second compound.

### TECHNICAL FIELD

The present invention pertains to methods for producing proton-conducting membranes for fuel cells by a radiografting technique, this technique involving the creation on a polymeric matrix of free radicals which will be able to react with appropriate compounds by free-radical reaction.

The field of application of the invention is therefore that of fuel cells, and more particularly of fuel cells comprising as their electrolyte a proton-conducting membrane, such as PEMFC fuel cells (Proton Exchange Membrane Fuel Cells).

### BACKGROUND ART

A fuel cell generally comprises a stack of individual cells within which an electrochemical reaction takes place between two continuously introduced reactants. The fuel, such as hydrogen in the case of cells operating with hydrogen/oxygen mixtures, is brought into contact with the anode, whereas the oxidant, generally oxygen, is brought into contact with the cathode. The anode and cathode are separated by an ion-conducting membrane electrolyte. The electrochemical reaction, the energy from which is converted into electrical energy, is broken down into two half-reactions:

an oxidation of the fuel, which takes place at the anode/electrolyte interface and, in the case of hydrogen fuel cells, produces protons H+, which will pass through the electrolyte in the direction of the cathode, and electrons, which rejoin the external circuit, so as to compete in the production of electrical energy;

a reduction of the oxidant, which takes place at the electrolyte/cathode interface, with production of water in the case of hydrogen fuel cells.

The electrochemical reaction takes place, properly speaking, in a membrane electrode assembly.

The membrane electrode assembly is a very thin assembly, with a thickness in the millimetre range, and each electrode is supplied with the appropriate gases, by means of a corrugated plate, for example.

The ion-conducting membrane is generally an organic membrane containing ionic groups which, in the presence of water, allow the conduction of the protons produced at the anode by oxidation of the hydrogen.

The thickness of this membrane is in general between 50 and 150 μm, and the result of a trade-off between the mechanical strength and the ohmic loss. This membrane also allows separation of the gases. The chemical and electrochemical resistance of these membranes generally allows the cell to operate for durations of more than 1000 hours.

The polymer constituting the membrane must therefore fulfil a certain number of conditions in relation to its mechanical, physiochemical and electrical properties, which are, inter alia, those defined below.

The polymer must first be able to give thin films, generally of 50 to 150 micrometres, which are dense and defect-free. The mechanical properties, modulus of elasticity, breaking stress, and ductility, must make the polymer compatible with the assembly operations, including, for example, a clamping between metal frames.

The properties must be maintained on passing from the dry state to the wet state.

The polymer must have good thermal stability to hydrolysis and must exhibit high resistance to reduction and to oxidation. This thermomechanical stability is assessed in terms of variation in ionic strength, and in terms of variation in mechanical properties.

The polymer, lastly, must have high ionic conductivity, this conductivity being provided by acid groups, such as carboxylic acid, phosphoric acid or sulphonic acid groups, which are linked to the chain of the polymer.

For a number of decades, different types of proton-conducting polymers have been proposed that can be used to constitute fuel cell membranes.

Employed first of all were sulphonated phenolic resins prepared by sulphonating polycondensed products, such as phenol-formaldehyde polymers.

The membranes prepared with these products are inexpensive, but do not have sufficient stability to hydrogen at 50-60° C. for long-lasting applications.

Attention then turned towards sulphonated polystyrene derivatives, which exhibit a higher stability than that of the sulphonated phenolic resins, but which cannot be used at more than 50-60° C.

At present, acceptable performance is obtained from polymers composed of a perfluorinated linear main chain and a side chain that carries a sulphonic acid group.

The best known of these polymers, which are available commercially, include the polymers registered under the Nafion® brand names from the company DuPont de Nemours.

The minimum proton conductivity of this polymer is 0.10 S/cm and its total acid capacity is from 0.95 to 1.01 meq/g. However, this polymer exhibits a high cost in the constitution of a fuel cell (20% to 30% of the total cost of the fuel cell), a limitation in terms of operating temperature (of the order of 80° C.) and a high level of hydration.

There is therefore a true need for production of proton-conducting membranes which are less inconvenient, by allowing operation of less expensive base materials whose conductivity can be controlled.

### SUMMARY OF THE INVENTION

Accordingly the invention provides a method for producing a proton-conducting membrane for a fuel cell, comprising successively:

a step of irradiating a polymeric matrix;

a step of grafting said polymeric matrix thus irradiated, by free-radical reaction with a first compound, comprising contacting said irradiated polymeric matrix with said first compound, which comprises at least one group capable of forming a covalent bond by free-radical reaction with said matrix, and comprises at least one reactive group capable of reacting with a group of a second compound, comprising at least one proton-conducting acid group, possibly in the form of salts, to form a covalent bond;

a step of contacting with the second compound the matrix thus grafted, whereby there is reaction between the reactive groups from the first compound and the appropriate groups of the second compound.

The above-stated method is based on the principle of radiografting, in other words on the principle of grafting by free-radical reaction with a polymeric matrix which has been irradiated beforehand.

The introduction of proton-conducting acid groups proceeds in two stages:

firstly, the grafting of the irradiated matrix by free-radical reaction of a first compound with said matrix, said first compound comprising a group capable of reacting with a group of a second compound to form a covalent bond;

secondly, the reaction of said second compound comprising at least one proton-conducting acid group with the reactive groups from the first compound, to form a covalent bond.

By virtue of the method of the invention, by adjusting the degree of irradiation of the matrix, it is possible to adjust the amount of compounds introduced that comprise a proton-conducting acid group, and hence it is possible to modify the proton conductivity of the resulting material. It is also possible to introduce different types of proton-conducting groups depending on the nature of the compounds reacted with the irradiated matrix.

The method of the invention comprises a step of irradiating a polymer matrix, the purpose of this irradiating step being to create free radicals within the material making up the matrix, this creation of free radicals being a consequence of the transfer of energy from the irradiation to said material.

The step of irradiating a polymeric matrix may comprise subjecting said matrix to an electron beam (also called electron irradiation). More particularly, this step may comprise sweeping the polymeric matrix with a beam of accelerated electrons, this beam possibly being emitted by an electron accelerator (for example, a Van de Graaf accelerator, 2.5 MeV). In the case of irradiation by electron beam, the deposition of energy is homogeneous, which means that the free radicals created by this irradiation will be distributed uniformly within the volume of the matrix.

The step of irradiating a polymeric matrix may also comprise subjecting said matrix to bombardment with heavy ions.

By heavy ions are meant ions whose mass is greater than that of carbon. Generally speaking, the ions in question are selected from krypton, lead and xenon.

More particularly, this step may comprise bombarding the polymer matrix with a beam of heavy ions, such as a beam of Pb ions with an intensity of 4.5 MeV/mau or a beam of Kr ions with an intensity of 10 MeV/mau.

From a mechanistic standpoint, when the energy-carrying heavy ion crosses the matrix, its velocity decreases. The ion gives up its energy, so creating damaged areas whose shape is approximately cylindrical. These areas are referred to as latent tracks, and comprise two regions: the track core and the track halo. The track core is a completely degraded zone, namely a zone in which the constituent bonds with the material are broken, producing free radicals. This core is also the region in which the heavy ion transmits a considerable amount of energy to the electrons of the material. Then, starting from this core, there is emission of secondary electrons, which will give rise to defects at a distance from the core, thus generating a halo.

In the case of irradiation with heavy ions, the deposition of energy is distributed as a function of the angle of irradiation, and is inhomogeneous. It is possible to create tracks arranged according to a predetermined scheme, and hence to induce, consequently, the grafting of compounds solely within the aforementioned tracks. It is therefore possible to induce different grafting schemes, by modifying the angle of irradiation relative to the normal of the faces of the matrix. This angle is advantageously between 15° and 60°—of the order of 30°, for example. It is possible to create, for example, a matrix comprising latent tracks crossing the matrix oriented in two symmetrical directions. It is possible to use two separate ion sources or to carry out irradiation in two directions in succession in order to create grafting schemes in which the latent tracks are crossed.

According to one particular embodiment, the irradiation step may proceed as follows:

irradiating the polymeric matrix with heavy ions;

chemically revealing, generally by hydrolysis, the latent tracks created by the passage of the heavy ions, at the end of which procedure open channels are obtained;

electronically irradiating said open channels, from which radiografting can proceed.

The chemical revealing involves contacting the matrix with a reagent capable of hydrolysing the latent tracks, so as to form hollow channels in their place.

According to this particular embodiment, following the irradiation of the polymeric matrix by heavy ions, the latent tracks produced have short chains of polymers, formed by scission of existing chains when the ion passes through the material during irradiation. Within these latent tracks, the rate of hydrolysis during the revealing procedure is greater than that in the unirradiated parts. Thus it is possible to carry out selective revealing. The reagents capable of providing for revealing of the latent tracks are a function of the material that makes up the matrix.

Thus, the latent tracks may in particular be treated with a highly basic and oxidizing solution, such as a 10N KOH solution in the presence of KMnO₄ at 0.25% by weight at a temperature of 65° C., when the polymeric matrix is composed, for example, of polyvinylidene fluoride (PVDF), poly(VDF-co-HFP) (vinylidene fluoride-co-hexafluoropropene), poly(VDF-co-TrFE) (vinylidene fluoride-co-trifluoroethylene), poly(VDF-co-TrFE-co-chloroTrFE) (vinylidene fluoride-co-trifluoroethylene-co-monochlorotrifluoroethylene) and other perfluorinated polymers. Treatment with a basic solution, optionally coupled with UV sensitization of the tracks, may be sufficient, for example, for polymers such as polyethylene terephthalate (PET) and polycarbonate (PC). The treatment leads to the formation of hollow cylindrical pores whose diameter can be modified as a function of the time of attack with the basic, oxidizing solution. Generally speaking, the irradiation with heavy ions will be carried out such that the membrane contains a number of tracks per cm² of between 10⁶ and 10¹¹. The number will typically be between 5×10⁷ and 5×10¹⁰, more especially around 10¹⁰. In any case, it is appropriate to verify that the mechanical properties of the membrane are not significantly diminished by the quantity of tracks.

Other information relating to the reagents and the operating conditions that can be used for chemical revealing as a function of the material making up the matrix may be found in Rev. Mod. Phys., Vol. 55, No. 4, October 1983, p. 925.

Following this revealing step, irradiation with electrons is carried out in order to induce the formation of free radicals on the wall of the channels, the procedure in this case being similar to that set out for electron irradiation in general, and allows the formation of a polymeric coating to fill up the pores. Generally speaking, the beam is oriented in a direction normal to the surface of the membrane, and the surface of the membrane is swept homogeneously. The irradiation dose varies generally from 10 to 200 kGy for subsequent radiografting; it will typically be close to 100 kGy for PVDF. The dose is generally such that it is greater than the gel dose, which corresponds to the dose from which recombination between radicals is favoured, producing inter-chain bonds which lead to the formation of a three-dimensional network (or else crosslinking) in other words the formation of a gel, in order at the same time to induce crosslinks which thus allow the mechanical properties of the final polymer to be improved. For PVDF, therefore, it is recommended that the dose should be at least 30 kGy.

The base polymeric matrix may be a matrix made of a polymer selected from polyurethanes, polyolefins, polycarbonates and polyethylene terephthalates, these polymers being advantageously fluorinated or even perfluorinated.

The polymeric matrix may preferably be selected from fluoropolymer matrices such as poly-vinylidene fluoride, tetrafluoroethylene-tetrafluoropropylene copolymers (known by the abbreviation FEP), ethylene-tetrafluoroethylene copolymers (known by the abbreviation ETFE), hexafluoropropene-vinylidene fluoride copolymers (known by the abbreviation HFP-co-VDF), vinylidene fluoride-trifluoroethylene copolymers (known by the abbreviation VDF-co-TrFE), and vinylidene fluoride-trifluoroethylene-monochlorotrifluoroethylene copolymers (known by the abbreviation VDF-co-TrFE-co-chloroTrFE).

Polymeric matrices based on fluoropolymers are advantageous, in the sense that they are resistant to corrosion, have good mechanical properties and exhibit low permeation to gases. They are therefore particularly suitable for constituting fuel cell membranes.

One particularly advantageous matrix of this type is a polyvinylidene fluoride matrix. Polyvinylidene fluoride is chemically inert (resistant in particular to corrosion), has good mechanical properties, and has a glass transition temperature of from −42° C. to −38° C., a melting point of 170° C. and a density of 1.75 g/cm³. It also exhibits low permeation to gases, making it particularly advantageous as a base for constituting membranes of fuel cells that operate with hydrogen as the fuel. This polymer is readily extruded and may be present, in particular, in two crystalline forms, depending on the orientation of the crystallites: the a phase and the β phase, the β phase being characterized in particular by piezoelectric properties.

As mentioned above, the step of irradiating the polymeric matrix allows the creation of free radicals within the material of the matrix. From a mechanistic standpoint, the creation of these free radicals is allowed by the energy generated by the irradiation, this energy being transferred to the material, and being reinforced by chain breakage and, consequently, by the creation of these radicals.

For example, in the case of polyvinylidene fluoride, the free radicals created are alkyl groups which carry a free electron.

The radicals present in an irradiated matrix of this kind may be trapped within crystallites, so as to prolong the lifetime of the matrix in irradiated form. It is therefore recommended that matrices be used comprising crystallites at preferably between 30% and 50%, generally 40%. Thus, for example, PVDF is semi-crystalline (it exhibits generally 40% crystallinity and 60% of amorphous form) and may be present in a number of crystalline phases, α, β, γ and δ, which are composed of the combination—planar or helical—of chains. The α and β phases are the most common. PVDF, which is a thermoplastic polymer, and can therefore be melted and then moulded, primarily of a phase, is generally obtained by cooling from the melt state, for example after simple extrusion. PVDF based primarily on β phase is generally obtained by low-temperature biaxial stretching, at less than 50° C., of primarily α-phase PVDF. It is recommended that PVDF comprising primarily β phase be used, since the crystallinity is greater in that case.

The first compound intended for contact with the irradiated matrix is advantageously a compound comprising an ethylenic group as a group capable of reacting by free-radical reaction to form a covalent bond, and a group selected from —CO₂H and —NH₂ as a reactive group, while the second compound will advantageously comprise, as a group which reacts with the reactive group of the first compound to form a covalent bond, a —NH₂ group when the reactive group of the first compound is a CO₂H group, or a —CO₂H group when the reactive group of the first compound is a —NH₂ group. In these two cases, the reaction between the reactive group of the first compound and the group of the second compound is an amidation reaction. It may be necessary to activate the carboxyl function in order to facilitate the reaction with a —NH₂ function of the second compound. Activation may involve reacting the —CO₂H function with a succinimide compound, to create a —CO—N-succinimide group, which is more reactive towards —NH₂ functions.

A compound which can be used as the first compound comprising a —CO₂H group as reactive group is acrylic acid.

Compounds which can be used as the first compound comprising a —NH₂ group as reactive group are vinyl amines.

The step of grafting of the first compound, when the group capable of being grafted is an ethylenic group, is divided into two phases:

a phase of reaction of the first compound with the irradiated matrix, this phase taking the form of an opening of the double bond by reaction with a free-radical centre of the matrix, the free-radical centre therefore “moving” from the matrix to a carbon atom from said first compound;

a phase of polymerization of this first compound, starting from the free-radical centre created on the grafted first compound.

In other words, the free radicals of the material that makes up the matrix give rise to propagation of the polymerization reaction of the first compound contacted with the matrix. In this particular case, therefore, the free-radical reaction is a free-radical polymerization reaction of the first compound contacted, starting from the irradiated matrix.

At the end of the polymerization phase, the membranes obtained will therefore comprise a polymeric matrix grafted with polymers containing repeating units obtained from the polymerization of the first compound contacted with the irradiated matrix.

If the first compound is represented by the formula=—R (where R represents a reactive group capable of reacting with a group of the second compound), the reaction scheme may be as follows:

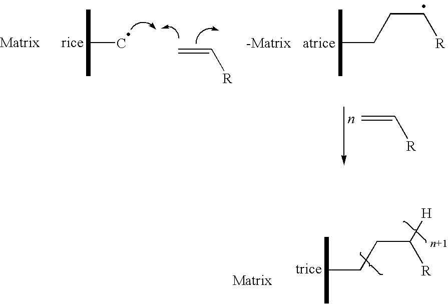

When the first compound is acrylic acid, the membranes at the end of the grafting step comprise a polymeric matrix grafted with grafts of poly(acrylic acid) type. Grafts of this kind carry —CO₂H groups which are capable of reacting with groups of a second compound (for example, —NH₂ groups) to form a covalent bond.

The membranes produced with a first compound of this kind will therefore have grafts of poly(acrylic acid) type, thus comprising a chain sequence of the following type:

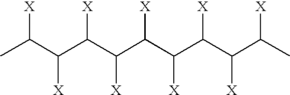

where X may represent —CO₂H.

The theoretical distances between two acidic protons may be evaluated at between 2.3 and 7 Å, which suggests that proton conduction will able to take place even at very low levels of hydration.

As a second compound comprising a —NH₂ group, mention may be made, advantageously, of amino acids, in other words compounds containing both an acid group, such as a —CO2H, —SO3H or —PO3H2 group, and an amino group —NH2.

Examples of amino acids that may be suitable include those conforming to one of the following formulae:

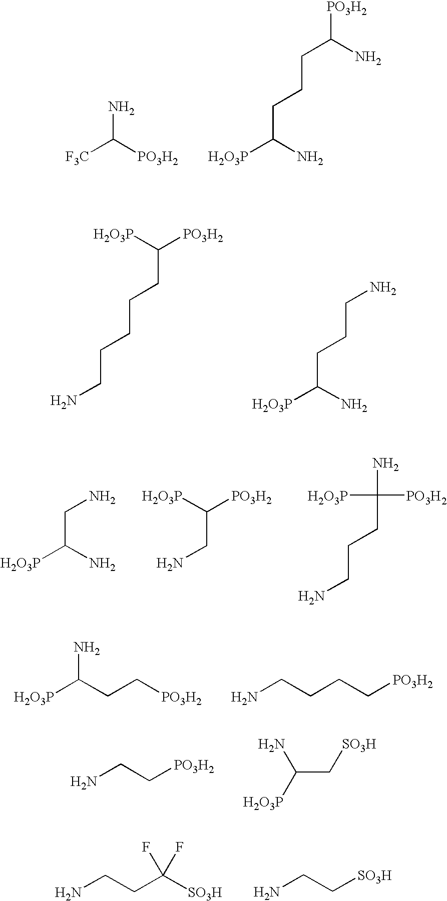

As a second compound comprising a —COOH group, mention may be made of the compounds corresponding to one of the following formulae:

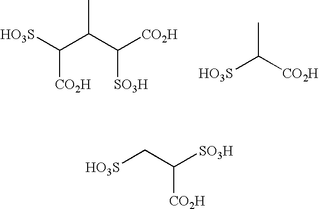

One particular example of a method in accordance with the invention is a method comprising:

a step of irradiating a polyvinylidene fluoride matrix;

a step of grafting said polymeric matrix thus irradiated, comprising contacting acrylic acid with said irradiated polymer matrix;

a step of contacting the matrix thus grafted, with taurine.

When the grafts resulting from the reaction of the first compound and, where appropriate, of the second compound contain —CO₂H groups, consideration may be given to subjecting the resulting membranes to a sulphonation step, allowing the —CO₂H groups to be converted into —SO₃H groups, by the action, for example, of chlorosulphonic acid.

The methods of the invention are methods which are simple and convenient to implement. They allow the amount of proton-conducting groups introduced into the membrane to be controlled. By adjusting the type of compounds grafted, it is possible to obtain membranes exhibiting a wide variety of stochiometries of proton donor species.

Consideration may be given to obtaining total acid capacities which may be greater than 0.95 to 1.1 meq/g (where meq/g corresponds to the number of moles of proton-exchange molecules or of equivalents (in this case acid) per gram of membrane). The total acid capacities are directly dependent on the degree of grafting used, on the number of proton-exchange functions introduced during the functionalization, and therefore on the nature of the graft.

Accordingly, the invention likewise provides proton-conducting membranes of a fuel cell that are obtainable by the method of the invention.

In particular, the membranes of the invention may correspond to membranes comprising a polymeric matrix grafted with grafts obtained by:

free-radical polymerization of a first compound comprising an ethylenic group and, as a reactive group, a group capable of reacting with a —CO₂H group, or a —NH₂ group, it being possible for this first compound to be acrylic acid;

reaction of the grafts obtained from the free-radical polymerization with a second compound, containing, as a group which reacts with the group of the first compound to form a covalent bond, a —NH₂ group when the reactive group of the first compound is a CO₂H group, or a —CO₂H group when the reactive group of the first compound is a —NH₂ group, it being possible for said second compound to be taurine when the first compound is acrylic acid.

More specifically, one particular membrane of the invention is a membrane comprising a polymeric matrix made of polyvinylidene fluoride, grafted with grafts obtained by:

free-radical polymerization of acrylic acid, producing poly(acrylic acid) chains;

reaction of the poly(acrylic acid) chains with taurine.

The membranes of the invention may be nanostructured. In particular they may be composed:

of a fluoropolymeric matrix possessing nanostructuring induced by irradiation with heavy ions;

of nanodomains bonded covalently to said matrix, composed of grafts which carry proton-conducting functions, and/or of nanodomains containing chains of said matrix which are bonded covalently and interpenetrated with different polymers (modified or not) of those referred to above.

The mutual orientation of these nanodomains is dependent on the conditions under which said matrix is irradiated with heavy ions. Since the path of the heavy ion is rectilinear, the nanodomains are continuous and form conduction channels. As an illustrative, non-limitative example: an orientation of the nanodomains perpendicular to the surfaces of said matrix and parallel with one another; a cruciform or mesh-like orientation of the nanodomains.

These nanodomains are bonded covalently to said matrix and are impermeable to gases. They constitute preferential conduction pathways for protons.

These membranes are intended for incorporation into fuel cell devices.

The invention accordingly further provides a fuel cell device comprising at least one membrane as defined above.

This device comprises one or more membrane electrode assemblies.

In order to produce such an assembly, the membrane may be placed between two electrodes, for example, made of carbon paper impregnated with a catalyst.

The assembly is then pressed at a temperature suitable to provide for effective adhesion between electrodes and membrane.

The membrane electrode assembly obtained is then placed between two plates, providing for electrical conduction and the supply of reactants to the electrodes. These plates are commonly referred to by the term “bipolar plates”.

The invention will now be described in relation to the following examples, which are given for illustration and not for limitation.

### BRIEF DESCRIPTION OF THE DRAWINGS

FIG. 1 is a photograph obtained by field-effect scanning electron microscopy (SEM), comprising two parts: one part (a), showing a PVDF matrix comprising revealed latent tracks, and one part (b) showing the said membrane radiografted in the latent tracks, as obtained in accordance with Example 1.3, before coupling with taurine.

FIG. 2 is a diagram showing a device for measuring the relative proton conductivity of a membrane.

FIG. 3 is a graph showing the resistivity R (in Ω) (solid curve) and the proton conductivity C (in mS/cm) (dotted curve) as a function of the flux F (ions/cm²) for a membrane obtained in accordance with Example 1.1, before coupling with taurine.

### DETAILED DESCRIPTION OF PARTICULAR EMBODIMENTS

### Example 1

This example illustrates the production of a membrane in accordance with the invention, in three variants:

a first variant involving only irradiation with heavy Pb²⁺ ions;

a second variant involving electron irradiation;

a third variant involving in succession irradiation with heavy Pb²⁺ ions and chemical revealing followed by electron irradiation.

### 1.1 —First Variant

A matrix with acrylic acid was employed. The number of moles of acid introduced was estimated using spectroscopic analyses.

This matrix was obtained as follows:

In a first stage, a matrix (6×30 cm, 9 μm in thickness) of polyvinylidene fluoride was subjected to bombardment with heavy Pb²⁺ ions. The flux varied from 5×10⁷ to 5×10¹⁰ ions per cm². This corresponds to a dose of from Gy to 1000 kGy. The loss of electron energy (dE/dx) is from 2.2 to 72.6 MeV cm² mg⁻¹ (0.39 to 12.8 keV nm⁻¹). The irradiation angle was set at 90°. This step produced latent tracks comprising free-radical species.

The matrices produced in accordance with this procedure were used immediately or stored under an inert atmosphere, such as nitrogen, and generally at low temperature (−18° C.), for a number of months before being used.

In a second stage, the irradiated matrix was contacted with acrylic acid by immersion in an aqueous solution, through which nitrogen had been bubbled for 15 minutes, containing 25% by mass of acid and 0.1% by mass of Mohr's salt, at 60° C. for 1 h with stirring. The Mohr's salt was used in order to limit the homopolymerization of the acrylic acid. The same protocol was carried out with ethyl acetate as solvent.

The resulting membrane was then withdrawn from the solution and subsequently cleaned with water and extracted with boiling water, using a Soxhlet apparatus, for 24 h. It was subsequently dried under a high vacuum for 12 h.

The degree of grafting, defined by reference to the increase in mass of the membrane before and after radiografting, is between 10% and 20% by mass.

The resulting matrix was immersed in a solution of acetonitrile or of a water/acetonitrile (1/3) mixture, of N-hydroxysuccinimide (1.2 equivalents, relative to the number of moles of acrylic acid introduced into the matrix; this value varies from 3 to 10 mmol/l and is generally around 8 mmol/l) and of carbodiimide (1 equivalent relative to the number of moles of acrylic acid introduced into the matrix) and was left with stirring at ambient temperature (25° C.) for 12 h.

The matrix was subsequently immersed for 12 h, with stirring and at ambient temperature, in a taurine solution (3 equivalents relative to the number of moles of acrylic acid introduced into the matrix) in a water/acetonitrile mixture (30/70) to which were added beforehand 6 equivalents (relative to the taurine) of diisopropylethylamine (DIPEA).

The resulting membrane was then washed with water and acetonitrile and subsequently dried under vacuum.

With a degree of grafting of acrylic acid of from 10 to 20% by mass (yield defined by reference to the increase in mass of the membrane before and after radiografting), and a functionalization yield of 40 to 50 mol % (yield established as a function of the number of modifiable functions introduced by radiografting), the resulting membranes have a total acid capacity of at least 0.58 meq/g. This capacity corresponds to the number of proton-exchange molecules or equivalents (in this case acid) per gram of membrane.

### 1.2—Second Variant

A matrix grafted with acrylic acid was employed.

This matrix was obtained as follows:

In a first stage, a matrix (6×30 cm, 9 μm in thickness) made of polyvinylidene fluoride was subjected to electron irradiation. The dose varied from 50 to 150 kGy. The irradiation angle was set at 90°. This step produced free radicals trapped within the crystallites of the PVDF.

In a second stage, the irradiated matrix was contacted with acrylic acid. For this purpose, the matrix was immersed in a solution, degassed beforehand, at 25% by mass of acid in water or ethyl acetate, and 0.1% by mass of Mohr's salt, at 60° C. for 1 h, with stirring. The Mohr's salt was employed in order to limit the homopolymerization of the acrylic acid. The resulting membrane was subsequently withdrawn from the solution and then cleaned with water and extracted with boiling water, using a Soxhlet apparatus, for 24 h. It was then dried under a high vacuum for 12 h.

The degree of grafting, defined by reference to the increase in mass of the membrane before and after radiografting, is between 10% and 40% by mass.

The resulting matrix was immersed in a solution of acetonitrile or of a water/acetonitrile mixture (1/3), of N-hydroxysuccinimide (1.2 equivalents, relative to the number of moles of acrylic acid introduced into the matrix) and of carbodiimide (1 equivalent, relative to the number of moles of acrylic acid introduced into the matrix), and was left with stirring at ambient temperature (25° C.) for 12 h.

The matrix was subsequently immersed for 12 h with stirring and at ambient temperature in a taurine solution (3 equivalents, relative to the number of moles of acrylic acid introduced into the matrix) in a water/acetonitrile mixture (30/70) to which had been added beforehand 6 equivalents (relative to the taurine) of DIPEA.

The resulting membrane was subsequently washed with water and acetonitrile and then dried under vacuum.

With a degree of grafting of acrylic acid of from 10% to 40% by mass (yield defined relative to the increase in mass of the membrane before and after radiografting), and a functionalization yield of 70 to 80 mol % (yield established as a function of the number of modifiable functions introduced by radiografting), the resulting membranes have a total acid capacity of at least 1.3 meq/g.

### 1.3—Third Variant

A matrix grafted with acrylic acid was employed.

This matrix was obtained as follows:

In a first stage, a matrix was irradiated as set out in paragraph 1.1.

In a second stage, the irradiated matrix was contacted with a 10N KOH solution in the presence of KMnO₄ at 0.25% by weight, at a temperature of 65° C., for a variable time of 15 min to 1 h. The treatment resulted in the formation of hollow cylindrical pores with a diameter which varied linearly with the attack time, i.e. from 25 nm to 100 nm.

In a third stage, the membrane obtained above is subjected to the electron irradiation treatment and the contacting of acrylic acid as described in paragraph 1.2.

The degree of grafting, defined by reference to the increase in mass of the membrane before and after radiografting, is between 5% and 30% by mass.

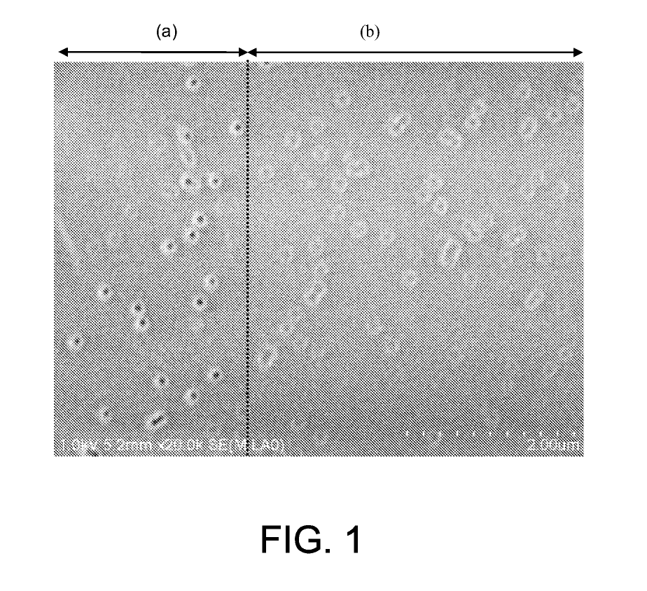

FIG. 1 shows an image obtained by field-effect Scanning Electron Microscopy (SEM) of a membrane grafted with acrylic acid. The part (a) corresponds to a zone for which the tracks were revealed; part (b) corresponds to a part for which radiografting was performed in the electron-irradiated tracks revealed, following irradiation.

Subsequently, the resulting matrix was immersed in a solution of acetonitrile or of a water/acetonitrile mixture (1/3), of N-hydroxysuccinimide (1.2 equivalents, relative to the number of moles of acrylic acid introduced into the matrix) and of carbodiimide (1 equivalent, relative to the number of moles of acrylic acid introduced into the matrix), and was left with stirring at ambient temperature (25° C.) for 12 h.

The matrix was subsequently immersed for 12 h, with stirring and at ambient temperature, in a taurine solution (3 equivalents, relative to the number of moles of acrylic acid introduced into the matrix) in a water/acetonitrile mixture (30/70) to which had been added beforehand 6 equivalents (relative to the taurine) of DIPEA.

The resulting membrane was subsequently washed with water and acetonitrile and then dried under vacuum.

With a degree of grafting of acrylic acid of from 5% to 30% by mass (yield defined relative to the increase in mass of the membrane before and after radiografting), and a functionalization yield of 80 to 90 mol % (yield established as a function of the number of modifiable functions introduced by radiografting), the resulting membranes have a total acid capacity of at least 1.5 meq/g.

### Example 2

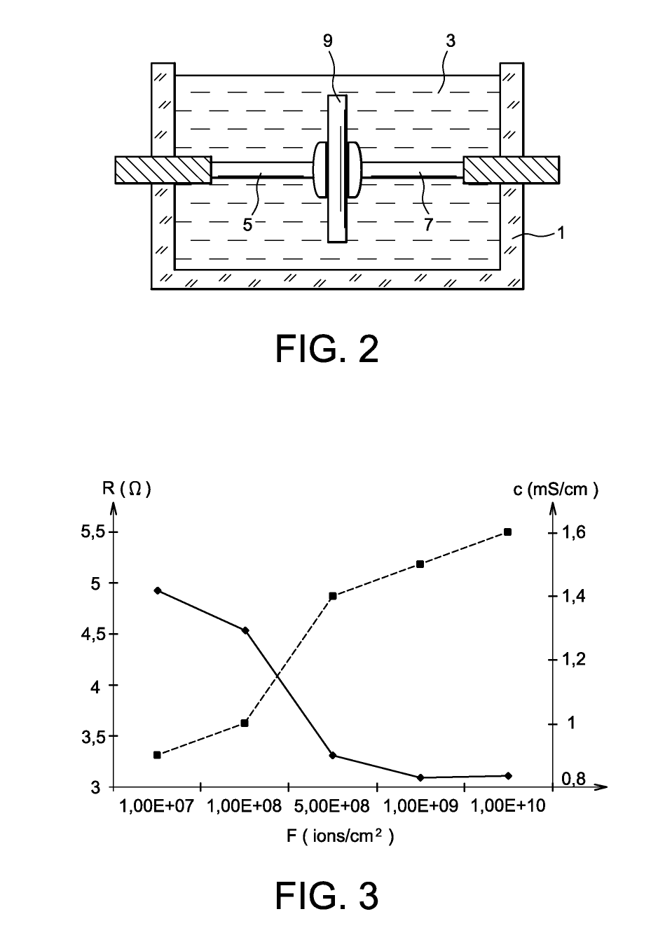

In order to study the effect of flux on the proton conductivity, membranes radiografted in accordance with the protocol of Example 1.1, with acrylic acid, prior to coupling with taurine, were tested in dry form in a device, shown in FIG. 2, which measures relative proton conductivity, said device comprising:

a plexiglass tank 1 filled with demineralized water 3;

a pair of platinum electrodes 5 and 7;

the membrane 9 disposed between the pair of platinum electrodes 5 and 7.

As shown by the curves in FIG. 3, the maximum conductivity was obtained, for a radiografted PVDF membrane, for a flux of 10¹⁰ tracks per square centimetre or 10¹⁰ channels per square centimetre.

1. Method for producing a proton-conducting membrane for a fuel cell, comprising successively:
a step of irradiating a polymeric matrix;
a step of grafting said polymeric matrix thus irradiated, by free-radical reaction with a first compound, comprising contacting said irradiated polymeric matrix with said first compound, which comprises at least one group capable of forming a covalent bond by free-radical reaction with said matrix, and comprises at least one reactive group capable of reacting with a group of a second compound, comprising at least one proton-conducting acid group, to form a covalent bond;
a step of contacting with the second compound the matrix thus grafted, whereby there is reaction between the reactive groups from the first compound and the appropriate groups of the second compound.

2. Method according to claim 1, wherein the irradiating step comprises subjecting said matrix to an electron beam.

3. Method according to claim 1, wherein the irradiating step comprises subjecting said matrix to heavy ion bombardment.

4. Method according to claim 3, wherein the heavy ions are selected from lead, krypton and xenon.

5. Method according to claim 1, wherein the irradiating step comprises the succession of the following steps:
irradiating the polymeric matrix with heavy ions;
chemically revealing the latent tracks created by the passage of the heavy ions, at the end of which open channels are obtained;
electronically irradiating said open channels.

6. Method according to claim 1, wherein the polymeric matrix is selected from polyurethane, polyolefin, polycarbonate or polyethylene terephthalate matrices.

7. Method according to claim 1, wherein the polymeric matrix is a fluoropolymer matrix.

8. Method according to claim 7, wherein the matrix is made of polyvinylidene fluoride, tetrafluoroethylene-tetrafluoropropylene copolymer, ethylene-tetrafluoroethylene copolymer, hexafluoropropene-vinylidene fluoride copolymer, vinylidene fluoride-trifluoroethylene copolymer or vinylidene fluoride-trifluoroethylene-monochlorotrifluoroethylene copolymer.

9. Method according to claim 1, wherein the matrix is made of polyvinylidene fluoride.

10. Method according to claim 1, wherein the first compound for contacting with the irradiated matrix is a compound comprising an ethylenic group as a group capable of reacting by free-radical reaction, to form a covalent bond, and a —CO₂H or —NH₂ group as a reactive group.

11. Method according to claim 10, wherein the first compound comprising a —CO₂H group as a reactive group is acrylic acid.

12. Method according to claim 10, wherein the first compound comprising a —NH₂ group as a reactive group is selected form vinyl amines.

13. Method according to claim 1, wherein the second compound comprises, as a group reacting with the group of the first compound to form a covalent bond, a —NH₂ group when the reactive group of the first compound is a —CO₂H group, or a —CO₂H group when the reactive group of the first compound is a —NH₂ group.

14. Method according to claim 13, wherein the second compound is an amino acid.

15. Method according to claim 14, wherein the second compound is selected from the amino acids of the following formulae:

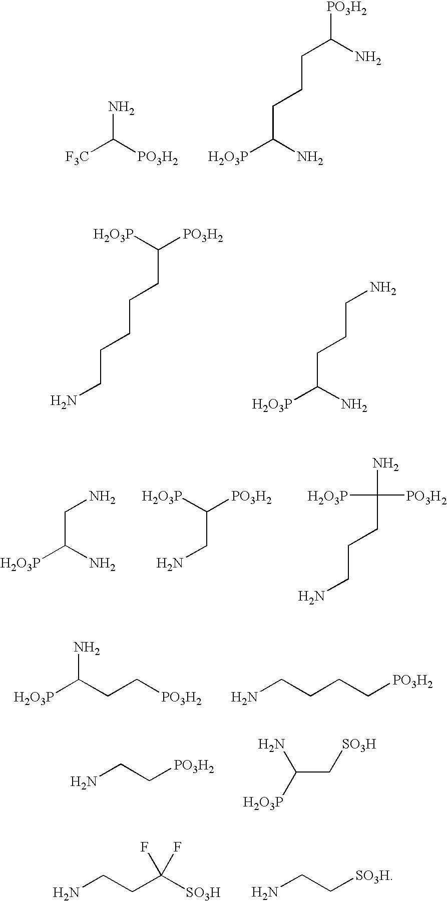

16. Production method according to claim 13, wherein the second compound is selected from the compounds of the following formulae:

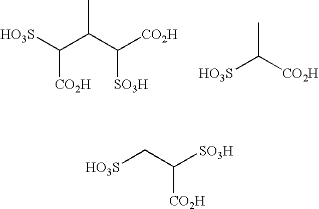

17. Method according to claim 1, wherein the polymeric matrix is a polyvinylidene fluoride matrix, the first compound is acrylic acid and the second compound is taurine.

18. Proton-conducting membrane for a fuel cell, obtainable by a method of irradiating a polymeric matrix; grafting said polymeric matrix thus irradiated, by free-radical reaction with a first compound, comprising contacting said irradiated polymeric matrix with said first compound, which comprises at least one group capable of forming a covalent bond by free-radical reaction with said matrix, and comprises at least one reactive group capable of reacting with a group of a second compound, comprising at least one proton-conducting acid group, to form a covalent bond; and contacting with the second compound the matrix thus grafted, whereby there is reaction between the reactive groups from the first compound and the appropriate groups of the second compound.

19. Membrane according to claim 18, which is nanostructured.

20. Fuel cell device comprising at least one membrane comprising a polymeric matrix made of polyvinylidene fluoride and grafted with grafts obtained by:
free-radically polymerizing acrylic acid, to generate poly (acrylic acid) chains;
reacting the poly (acrylic acid) chains with taurine.
